(19) United States
(12) Patent Application Publication
(10) Pub. No.: US 2004/0094588 A1
(43) Pub. Date: May 20, 2004

(54) Vehicle container accessory

(76) Inventor: Don W. Klein, Cedarburg, WI (US)

Correspondence Address: FOLEY & LARDNER, 777 EAST WISCONSIN AVENUE, SUITE 3800, MILWAUKEE, WI, 53202-5308, US

(21) Appl. No.: 10/714,701

(22) Filed: Nov. 17, 2003

Related U.S. Application Data
(60) Provisional application No. 60/426,880, filed on Nov. 15, 2002.

(51) Int. Cl. B60R 7/00; B60R 7/05

(52) U.S. Cl. 224/312

(57) ABSTRACT

A container accessory for use with a vehicle component that pivots between a raised position and a lowered position includes at least one panel configured to be coupled to the component. The at least one panel includes at least one holding mechanism. The at least one panel is configured to pivot between a stowed position in which the at least one panel extends parallel to the component along a bottom side of the component when the component is in the raised position and a deployed position in which the at least one panel extends downwardly from the component when the component is in the raised position.

### CROSS-REFERENCE AND RELATED APPLICATIONS

The present application claims priority from U.S. Provisional Patent Application Serial No. 60/426,880 filed on Nov. 15, 2002 by Don W. Klein and entitled VEHICLE CONTAINER ACCESSORY, the full disclosure which is hereby incorporated by reference.

### BACKGROUND

Today's society has become increasingly mobile. As a result, transportation vehicles are more frequently used and are used for longer trips. Such vehicles are commonly provided with a myriad of compartments, drawers, pouches and the like to store various items that the driver or passengers of the vehicle may require during a trip. One example of such a vehicle container accessory is a visor mounted case.

Known cases mount to a visor such that pouches, pockets or other structures for containing items extend on a top side of a visor when the visor is in a raised position. In many vehicles, the visor itself must be stowed in the raised position in very close proximity to the headliner of the vehicle. Because the case extends between the visor and the headliner of the vehicle when the visor is in a raised position, there is a greater tendency for the visor to accidentally rotate or fall to a deployed position. In addition, when the visor is in a raised position the limited space between the visor and the headliner limits the size or number of items that may be stored in the case.

### BRIEF DESCRIPTION OF THE DRAWINGS

FIG. 1 is a front plan view of an example of a container accessory of the present invention in a fully deployed state.

FIG. 2 is a rear plan view of the container accessory of FIG. 1.

FIG. 3 is a side perspective view of the container accessory of, FIG. 1 in completely folded state.

FIG. 4 illustrates the container accessory of FIG. 3 in a partially deployed state.

FIG. 5 is a side perspective view of the container accessory of FIG. 1 coupled to a sun visor of a motor vehicle with the sun visor in a raised position in which the sun visor extends along a headliner of the vehicle towards a rear of the vehicle and in which the container accessory is in a completely folded state.

FIG. 6 is a perspective view of the container accessory of FIG. 5 with the sun visor in a lowered position.

FIG. 7 is a perspective view of the sun visor of FIG. 5 illustrating the container accessory in a partially deployed state while the sun visor is in the raised position.

FIG. 8 is a rear perspective view of the container accessory of FIG. 7 in a fully deployed state with the sun visor in the raised position.

FIG. 9 is a front perspective view of the container accessory of FIG. 8.

FIG. 10 is a perspective view of an alternative embodiment of the container accessory of FIGS. 1-9 in a completely folded state and coupled to a sun visor in a raised position.

FIG. 11 is a perspective view of the container accessory of FIG. 10 in a fully deployed state.

FIG. 12 is a front elevational view of the container accessory in a completely folded state while being coupled to the sun visor while the sun visor is in the lowered position.

### FIELD OF THE INVENTION

The present invention relates to container accessories configured to be removably mounted to portions of transportation vehicles such as cars, boats, bicycles, motorcycles and the like. In particular, the invention relates to such a container accessory particularly configured to be mounted to a pivoting vehicle component that moves between a raised position and a lowered position such as an automobile visor. In the particular embodiment illustrated, the container accessory is configured to contain various cosmetic items.

### DETAILED DESCRIPTION OF THE EXAMPLE EMBODIMENTS

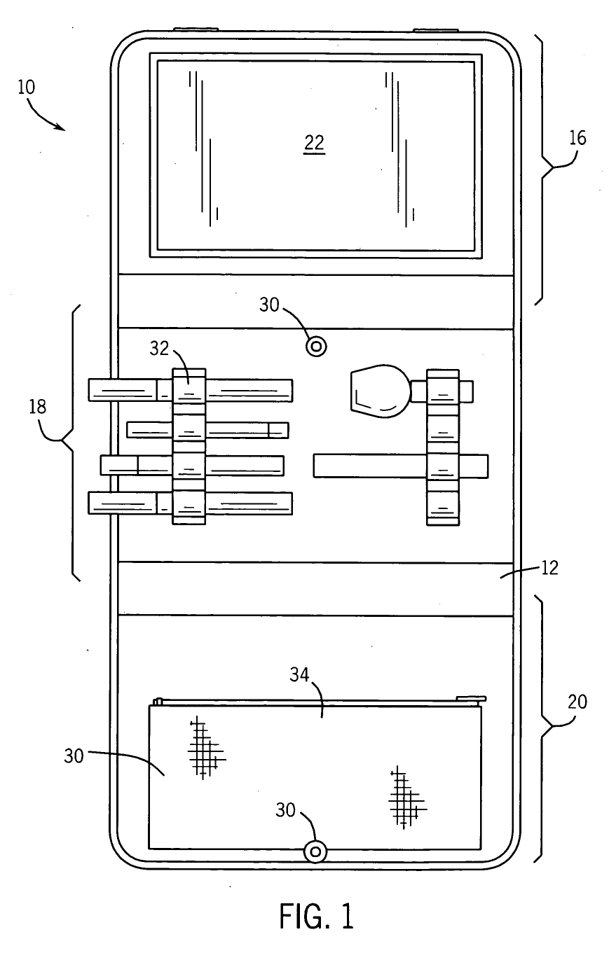

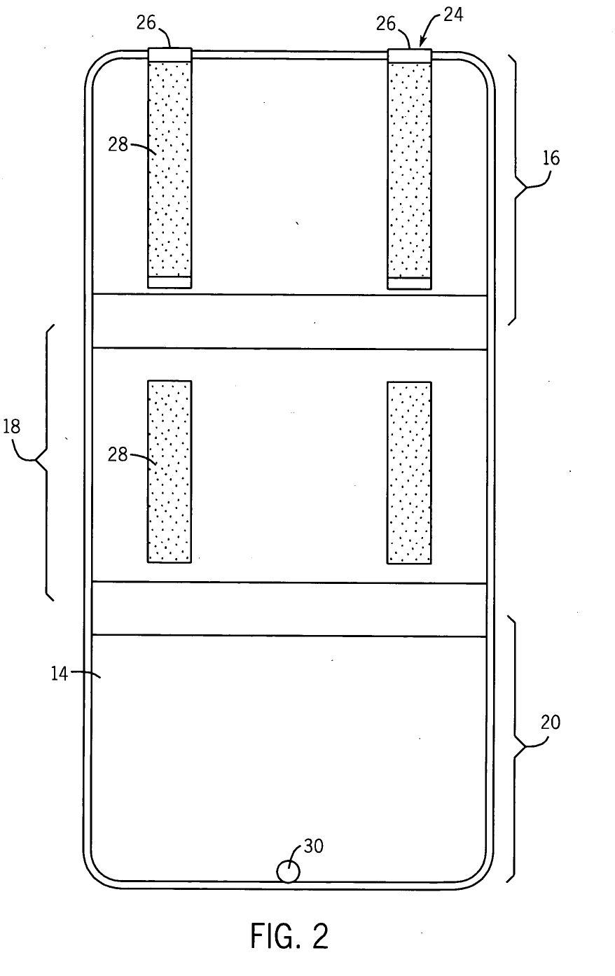

FIGS. 1-9 illustrate container accessory 10. As shown by FIGS. 1 and 2, container accessory 10 generally comprises an elongate foldable member having a first side 12 (shown in FIG. 1) and a second side 14 (shown in FIG. 2). Accessory 10 generally consists of three portions 16, 18 and 20. Side 12 of portion 16 includes a mirror 22. As shown by FIG. 2, side 14 of portion 16 includes visor mounting mechanism 24. Visor mounting mechanism 24 is configured to mount accessory 10 to a pivoting vehicle component that moves between a raised position and a lowered position such as a sun visor of an automobile. In the particular embodiments illustrated, mechanism 24 comprises a pair of at least partially elastic straps 26. Straps 26 are sized and are sufficiently elastomeric so as to stretch about a sun visor and to support accessory 10 upon a sun visor with portion 18 located on an opposite side of the visor as portion 16. In other embodiments, each of straps 26 may have two ends that wrap about a visor and that releasably connect to one another such as with a hook and loop fastener. In lieu of a pair of straps, mechanism 24 may alternatively comprise a single elongate sleeve or strap, a rigid clip or other conventionally known or future developed mechanisms which would enable portion 16 to be mounted to a sun visor in a plane substantially parallel to the sun visor. For example, mechanism 24 may alternatively comprise pads or other mechanism having one component of a hook and loop fastener system, wherein the pads or components are configured to be permanently or releasably attached to a sun visor with adhesives, fasteners and the like, wherein portion 16 includes the other portion of the hook and loop fastener system. In one embodiment, portion 18 may simply attach to the underside of the visor when the visor is in a raised position without requiring any member such as straps 26 to extend about the visor. In yet other embodiments, portion 18 itself may be permanently attached to or formed as part of the underside of the visor, wherein the underside of the visor is that surface of the visor which faces downward when the visor is in a raised position.

As further shown by FIG. 2, portion 16 additionally includes coupling mechanism 28. Coupling mechanism 28 generally comprises a mechanism configured to releasably secure side 14 of portion 18 substantially adjacent to side 14 of portion 16 such that portions 16 and 18 extend substantially parallel to one another. In the particular embodiment illustrated, coupling mechanism 28 comprises a first component of a hook and loop fastener secured to straps 26 and a second component of a hook and loop fastener secured to side 14 of portion 18. In alternative embodiments, coupling mechanism 28 may comprise hook and loop fastener components mounted directly to portions 16 and 18 (not on straps 26). In yet alternative embodiments, other releasable fastening mechanisms such as snaps, clips and the like may be employed.

As best shown by FIG. 1, portions 18 and 20 include an additional coupling mechanism 30 configured to releasably retain side 12 of portion 20 adjacent to side 12 of portion 18 such that portions 18 and 20 extend substantially parallel to one another when joined to one another by mechanism 30. In the particular embodiments illustrated, mechanism 30 comprises portions of a snap fastener. In alternative embodiments, other mechanisms may be used such as portions of a hook and loop fastener system, clips and the like. Coupling mechanisms 28 and 30 enable portions 16, 18 and 20 to be compactly retained in a Z-fold arrangement upon a vehicle visor.

As further shown by FIGS. 1 and 2, side 12 of portions 18 and 20 additionally include holding mechanisms 32, 34. Holding mechanism 32 comprise a plurality of elastic strips which form loops that receive and hold cosmetic accessories. Holding mechanism 34 comprises a zippered pouch coupled to side 14 of portion 20. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

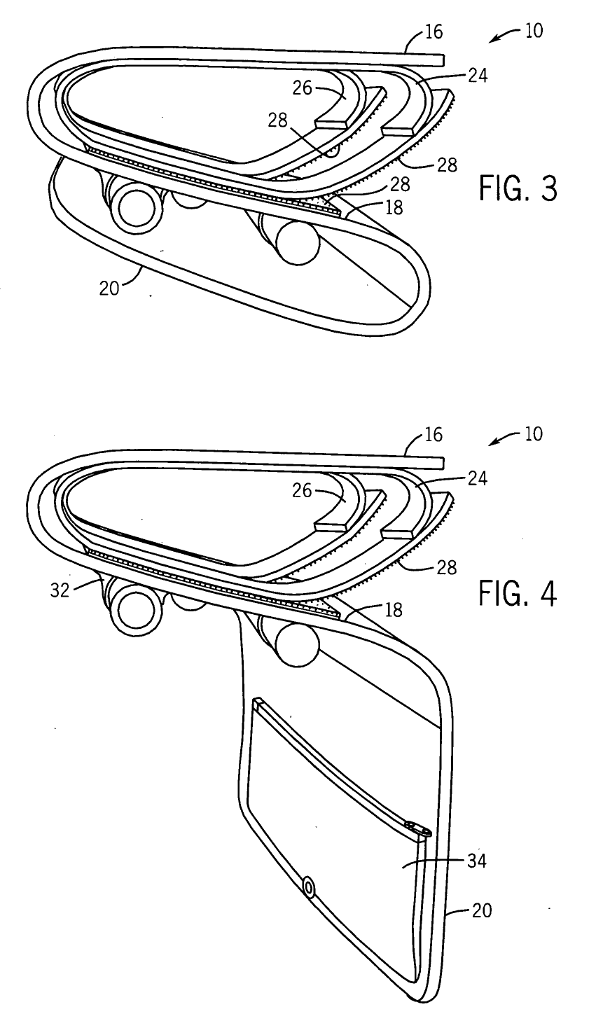

FIG. 3 illustrates accessory 10 in a completely folded state in which mechanism 24 secures accessory 10 to a vehicle visor, in which coupling mechanism 28 secures side 14 of portions 16 and 18 to one another and in which coupling mechanism 30 (shown in FIG. 1) releasably secures side 12 of portions 18 and 20 adjacent to one another. FIG. 4 illustrates coupling mechanism 30 released, enabling portion 20 to be folded away from portion 18 for access to components held by hold mechanism 32 and 34.

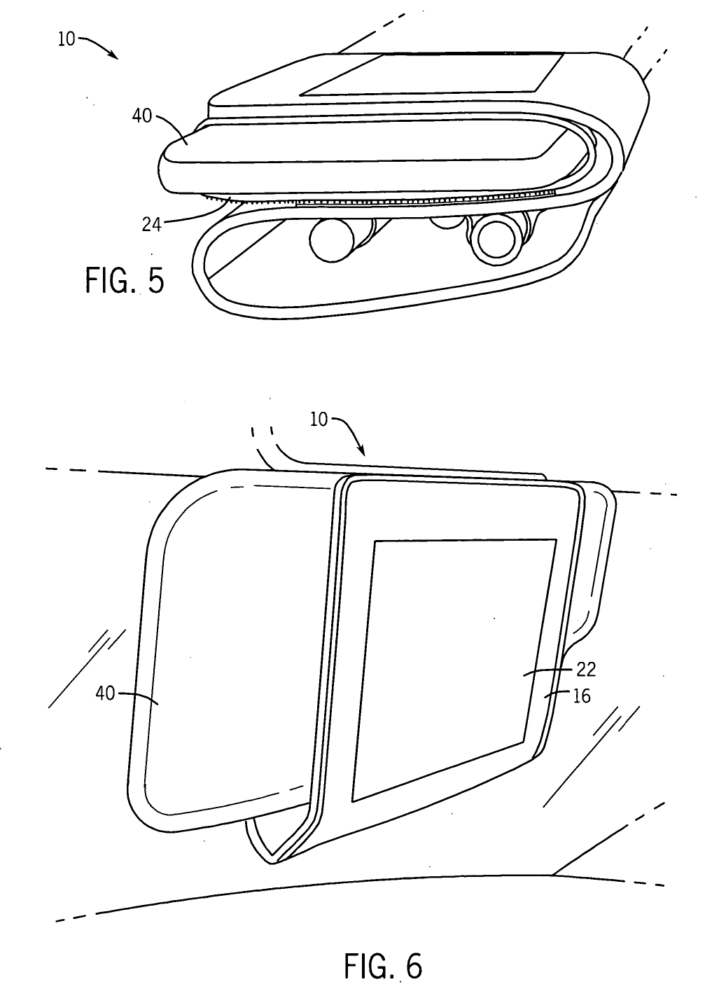

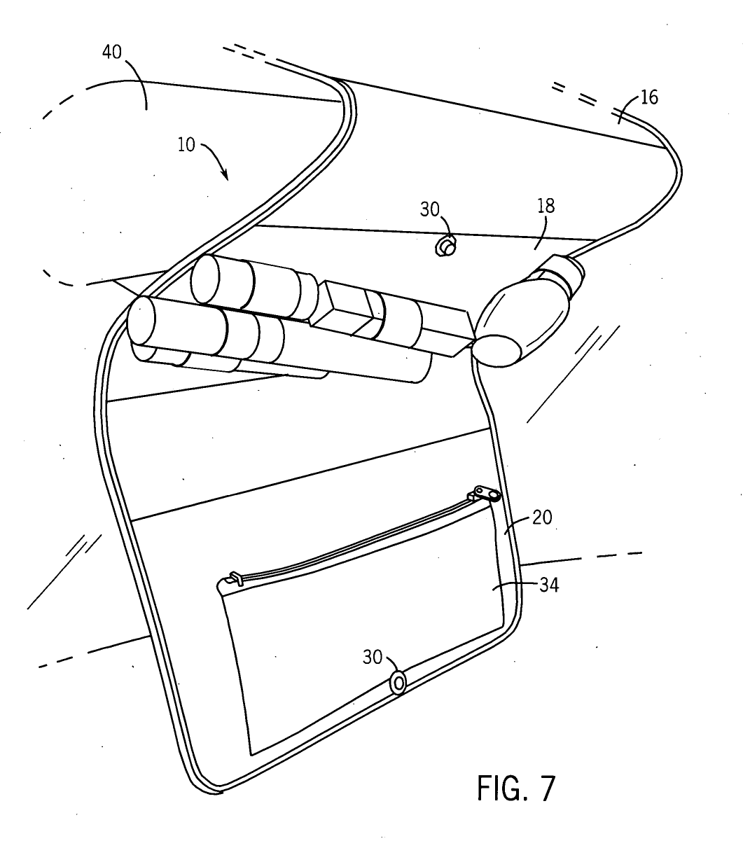

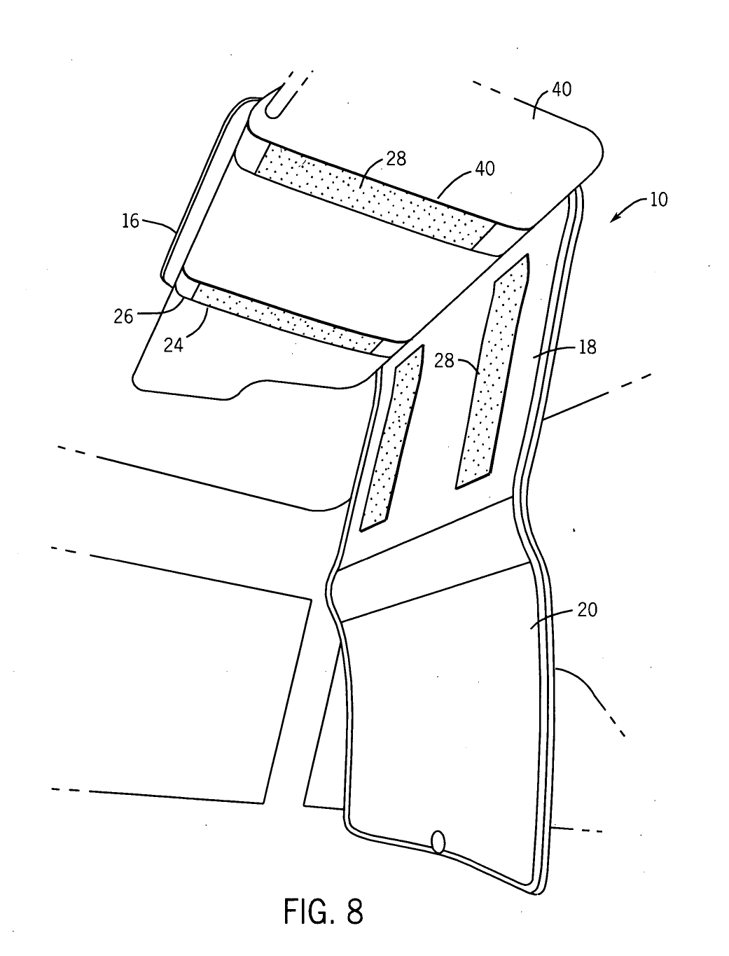

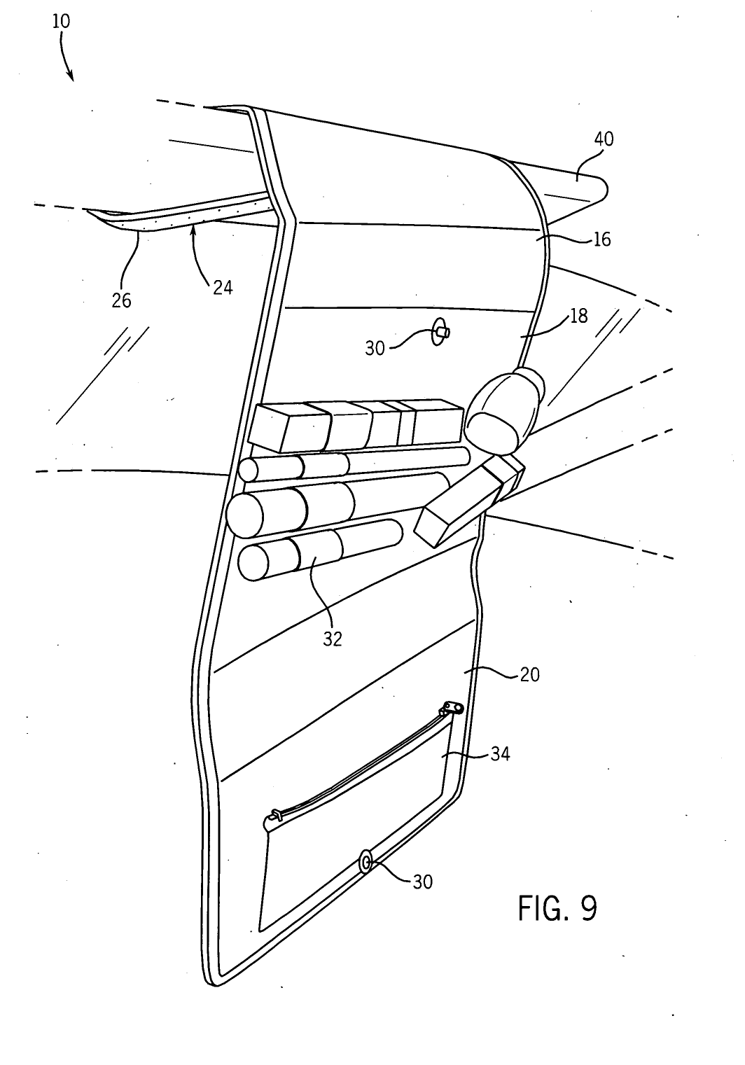

FIGS. 5-9 illustrate accessory 10 in use on a vehicle sun visor 40. FIG. 5 illustrates straps 26 of mechanism 24 encircling visor 40 and mounting accessory 10 to visor 40. FIG. 5 illustrates accessory 10 in the completely folded state with visor 40 in a raised position. FIG. 6 illustrates visor 40 pivoted to a lowered position. As shown in FIG. 6, when visor 40 is in the lowered position, mirror 26 is exposed enabling its use. FIG. 7 illustrates visor 40 in the raised position once again with coupling mechanism 30 released enabling access to holding mechanism 32 and 34. FIG. 8 illustrates coupling mechanism 28 released while visor 40 is in a raised position. As shown by FIG. 9, when coupling mechanisms 28 and 30 are released, portions 18 and 20 hang from visor 40 to provide full access.

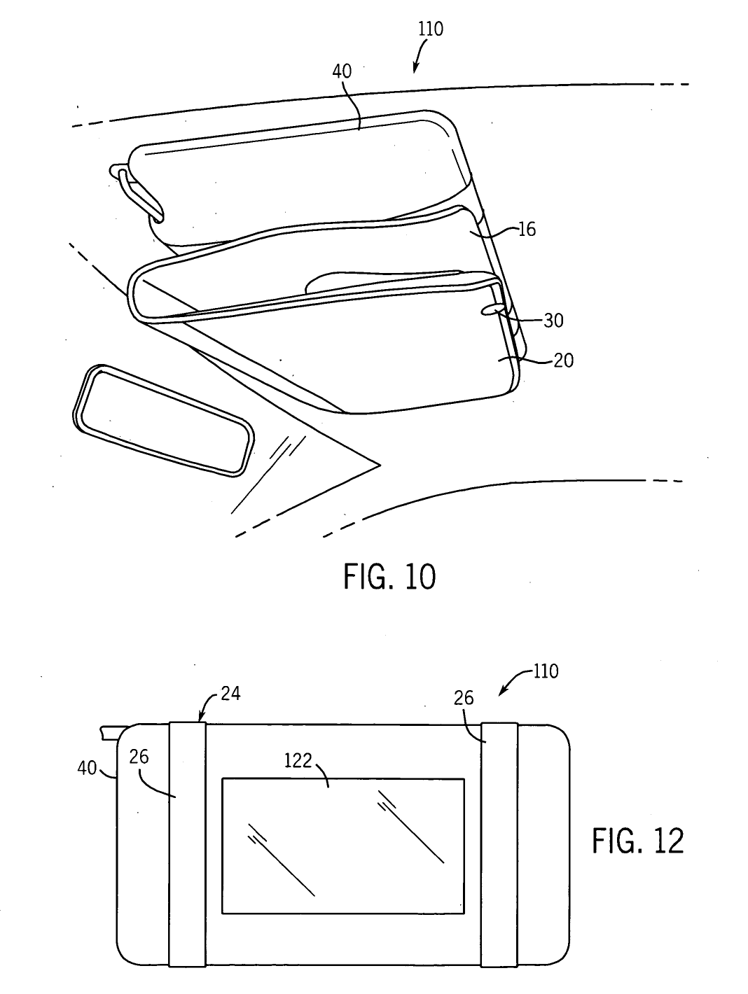

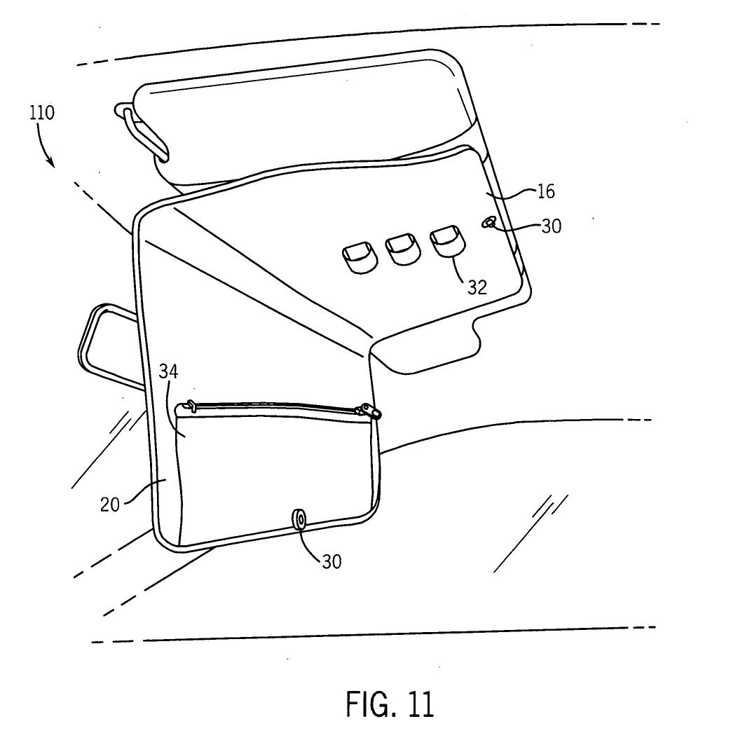

FIGS. 10 and 11 illustrate accessory 110, an alternative embodiment of accessory 10. Accessory 110 is similar to accessory 10 except that accessory 110 omits intermediate portion 18 and directly joins portions 16 and 20 on a fold line. In addition, portion 20 is joined to portion 16 along an opposite edge of portion 16 as compared to the juncture of portions 16 and 18 in accessory 10. As a result, portion 16 extends below, not above, visor 40 when visor 40 is in the raised position. In accessory 110, holders 32 are directly coupled to side 12 of portion 16.

As shown by FIG. 12, which illustrates visor 40 in a lowered position as seen from a person seated in the vehicle, visor 40 includes a mirror 122 situated on visor 40 such that the mirror faces upwards towards the headliner of the vehicle when visor 40 is in the raised position shown in FIG. 10. Straps 26 of mounting mechanism 24 are preferably sized and located sufficiently apart from one another such that straps 26 extend along opposite sides of the mirror when supporting accessory 110 upon visor 40. As a result, the mirror of visor 40 may still be utilized in conjunction with accessory 110. FIGS. 10 and 11 illustrate visor 40 in a raised position. FIG. 10 illustrates accessory 110 in a folded state adjacent to visor 40 by coupling mechanism 30. FIG. 11 illustrates coupling mechanism 30 released, allowing portion 20 to fall away from portion 16 and providing the vehicle occupant access to holding mechanism 32 and 34.

Although accessory 10 is illustrated as including holding mechanisms 32 and 34 specifically configured for holding cosmetics and the like, accessory 10 may include other alternative holding mechanisms so as to enable accessory 10 to be utilized for holding compact discs, tapes, memory cards, food items, writing instruments, portable electronic devices, grooming articles, lighters or various other relatively small components. In alternative embodiments, holding mechanisms 32 and 34 may comprise an elastic or inelastic rope, cord or other elongate flexible member having a first end secured to accessory 10 and a second end permanently or releasably secured to an item such that if the item is accidentally dropped, the item will hang from accessory 10. In such an embodiment, accessory 10 may additionally include means for releasably securing the item and its tether adjacent to accessory 10. For example, in one embodiment, the tether adjacent the item being held may include a snap, a first portion of a hook and loop fastener system, a clip or other fastening mechanism configured to cooperate with a corresponding opposite fastening mechanism such as a snap, a second portion of a hook and loop fastening system, a clipping surface or the like adjacent to accessory 10. Furthermore, in lieu of being mounted to a vehicle sun visor, accessory 10 may alternatively be configured for being mounted to a head rest post behind a vehicle seat for use by rear seat passengers or may be configured for use on other vehicles such as motorcycles, bicycles and the like.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the above definitions is manifestly intended to be as broad as possible. For example, unless specifically otherwise noted, the claims reciting a single particular element also encompass a plurality of such particular elements.

1. A container accessory for use with a vehicle component that pivots between a raised position and a lowered position, the accessory comprising:
at least one panel configured to be coupled to the component, wherein the at least one panel includes at least one holding mechanism and wherein the at least one panel is configured to pivot between a stowed position in which the at least one panel extends parallel to the component along a bottom side of the component when the component is in the raised position and a deployed position in which the at least one panel extends downwardly from the component when the component is in the raised position.

2. The accessory of claim 1, wherein the at least one panel includes:
a first panel; and
a second panel pivotally coupled to the first panel, wherein the first panel and the second panel pivot relative to one another between a fully stowed state in which both panels extend parallel to the component along a bottom side of the component when the component is in the raised position, an intermediate state in which the first panel extends parallel to the component along the bottom side of the component while the second panel extends downward from the component while the component is in the raised state, and a fully deployed state in which both the first panel and the second panel extend downward from the component when the component is in the raised state.

3. The accessory of claim 1 including a mirror coupled to the at least one panel and configured to extend along a top side of the component when the component is in the raised position.

4. The accessory of claim 1, wherein the at least one holding mechanism is configured to hold or contain cosmetics.

5. The accessory of claim 1, including means for releasably retaining the at least one panel in the stowed position.

6. The accessory of claim 1, wherein the at least one panel pivots about a living hinge.

7. The accessory of claim 1, including at least one member coupled to the at least one panel and configured to at least partially extend about the vehicle component.

8. The accessory of claim 7, wherein the at least one member is at least partially elastomeric.

9. The accessory of claim 7 including a retainer coupled to the at least one elastomeric member and configured to releasably retain the first panel parallel to the component.

10. The accessory of claim 1, wherein the vehicle component comprises a vehicle sun visor and wherein the accessory is configured to be coupled to the visor.

11. The accessory of claim 1, wherein the vehicle component pivots about a first axis between the raised position and the lowered position, wherein the at least one panel pivots about a second axis between the stowed position and the deployed position, and wherein the second axis extends parallel to the first axis.

12. The accessory of claim 11, wherein the retainer comprises a first portion of a hook and loop fastener coupled to the at least one elastomeric member and a second portion of a hook and loop fastener coupled to the first panel.

13. The container accessory of claim 1, wherein the at least one panel includes:
a first panel; and
a second panel pivotally coupled to the first panel, wherein the first panel and the second panel pivot relative to one another between a fully stowed state in which both panels extend parallel to the component along a bottom side of the component when the component is in the raised position, an intermediate state in which the first panel extends parallel to the component along the bottom side of the component while the second panel extends downward from the component while the component is in the raised state, and a fully deployed state in which both the first panel and the second panel extend downward from the component when the component is in the raised state and wherein the accessory further includes a mirror coupled to the first panel such that the first panel extends between the mirror and the vehicle component when the component is in the raised position.

14. The accessory of claim 1 wherein the vehicle component includes a mirror adapted to face a headliner of the vehicle when the component is in the raised position and wherein the accessory includes a first strap and a second strap coupled to the at least one panel and configured to extend on opposites of the mirror.

15. The accessory of claim 1 including:
a first panel having at least one holding mechanism and configured to be coupled to the component so as to extend parallel to the component along a bottom side of the component when the component is in the raised position, wherein the at least one panel includes:
a second panel having at least one second pocket or holder and configured to pivot between the stowed position in which the second panel extends parallel to the component along a bottom side of the component when the component is in the raised position and a deployed position which the second panel extends downward from the component when the component is in the raised position.

16. The accessory of claim 15 including a third panel coupled to the first panel and configured to extend parallel to the component along a top side of the component when the component is in the raised position.

17. The accessory of claim 16 including a mirror coupled to the third panel so as to face away from the component.

18. The accessory of claim 16 including a fastening mechanism configured to releasably fasten the second panel to the first panel such that the second panel extends substantially parallel to the first panel.

19. A visor system for a vehicle, the visor system comprising:
a sun visor configured to be pivotally supported by the vehicle for movement between a raised position in which the sun visor extends towards the rear of the vehicle along a headliner of the vehicle and a lowered position, the sun visor having a top side facing the headliner when the sun visor is in the raised position and an opposite bottom side; and
at least one panel coupled to the sun visor, wherein the at least one panel includes at least one holding mechanism and
wherein the at least one panel is configured to pivot between a stowed position in which the at least one panel is substantially parallel to the bottom side of the sun visor and a deployed position in which the at least one panel extends non-parallel from the bottom side of the sun visor.

20. The system of claim 19 wherein the at least one panel includes:
a first panel; and
a second panel pivotably coupled to the first panel, wherein the first panel and the second panel pivot relative to one another between a fully stowed state in which both panels extend parallel to the bottom side of the component, an intermediate state in which the fist panel extends parallel to the bottom side of the component while the second panel extends non-parallel to the bottom side of the component and a fully deployed state in which both the first panel and the second panel extend non-parallel to the bottom side of the component.

21. The system of claim 19 including a mirror coupled to the at least one panel and configured to extend along a top side of the visor when the visor is in the raised position.

22. The system of claim 19, wherein the at least one holding mechanism is configured to hold or contain cosmetics.

23. The system of claim 19, including means for releasably retaining the at least one panel in the stowed position.

24. The system of claim 19, wherein the at least one panel pivots about a living hinge.

25. The system of claim 19, including at least one member coupled to the at least one panel and configured to at least partially extend about the sun visor.

26. The system of claim 25, wherein the at least one member is at least partially elastomeric.

27. The system of claim 25 including a retainer coupled to the at least one elastomeric member and configured to releasably retain the first panel parallel to the visor.

28. The system of claim 19, wherein the visor pivots about a first axis between the raised position and the lowered position, wherein the at least one panel pivots about a second axis between the stowed position and the deployed position, and wherein the second axis extends parallel to the first axis.

29. The system of claim 28, wherein the retainer comprises a first portion of a hook and loop fastener coupled to the at least one elastomeric member and a second portion of a hook and loop fastener coupled to the first panel.

30. The system of claim 19, wherein the at least one panel includes:
a first panel; and
a second panel pivotally coupled to the first panel, wherein the first panel and the second panel pivot relative to one another between a fully stowed state in which both panels extend parallel to the visor along a bottom side of the visor when the visor is in the raised position,
an intermediate state in which the first panel extends parallel to the visor along the bottom side of the visor while the second panel extends downward from the visor while the visor is in the raised state, and
a fully deployed state in which both the first panel and the second panel extend downward from the visor when the visor is in the raised state and
wherein the accessory further includes a mirror coupled to the first panel such that the first panel extends between the mirror and the visor when the visor is in the raised position.

31. The system of claim 19 wherein the visor includes a mirror adapted to face a headliner of the vehicle when the visor is in the raised position and wherein the accessory includes a first strap and a second strap coupled to the at least one panel and configured to extend on opposites of the mirror.

32. The system of claim 19 including:
a first panel having at least one holding mechanism and configured to be coupled to the visor so as to extend parallel to the visor along a bottom side of the visor when the visor is in the raised position, wherein the at least one panel includes:
a second panel having at least one second holding mechanism and configured to pivot between the stowed position in which the second panel extends parallel to the component along a bottom side of the visor when the visor is in the raised position and a deployed position which the second panel extends downward from the visor when the visor is in the raised position.

33. The system of claim 20 including a third panel coupled to the first panel and configured to extend parallel to the visor along a top side of the visor when the visor is in the raised position.

34. The system of claim 33 including a mirror coupled to the third panel so as to face away from the visor.

35. The system of claim 33 including a fastening mechanism configured to releasably fasten the second panel to the first panel such that the second panel extends substantially parallel to the first panel.

36. A container accessory for use with a vehicle sun visor that pivots between a raised position and a lowered position, the accessory comprising:
storage means configured to be coupled to the sun visor, wherein the storage means includes at least one holding mechanism and wherein the storage means is configured to pivot between a stowed position in which the storage means extends adjacent to a bottom side of the visor when the visor is in the raised position and a deployed position in which the storage means extends away from the visor when the visor is in the raised position.

37. A method for accessing items supported by a sun visor, the method comprising:
pivoting a storage member relative to the sun visor while the sun visor is in a raised position in which the sun visor extends towards the rear of a vehicle adjacent a headliner of the vehicle; and
removing at least one item from at least one of a pocket of a holder of the storage member.

38. The method of claim 37 including:
pivoting a second storage member having at least one holding mechanism relative to the first storage member.

39. The method of claim 37 including pivoting the sun visor toward the lowered position while the first storage member is deployed.

40. The method of claim 38 including pivoting the sun visor to the lowered position while the first storage member and the second storage member are in deployed positions.
